(19) United States
(12) Patent Application Publication
(10) Pub. No.: US 2013/0033709 A1
(43) Pub. Date: Feb. 7, 2013

(54) INTERFEROMETRIC POSTURE DETECTION SYSTEM

(71) Applicants: Laurent POTIN, Coutras (FR); Bruno Barbier, Bordeaux (FR); Siegfried Rouzes, Le Haillan (FR)

(72) Inventors: Laurent POTIN, Coutras (FR); Bruno Barbier, Bordeaux (FR); Siegfried Rouzes, Le Haillan (FR)

(21) Appl. No.: 13/566,949

(22) Filed: Aug. 3, 2012

(30) Foreign Application Priority Data
Aug. 5, 2011 (FR) 1102461

(51) Int. Cl. G01B 11/26

(52) U.S. Cl. 356/492; 356/508

(57) ABSTRACT

The general field of the invention is that of optical systems for detection of the orientation of mobile objects in space. The main application is helmet posture detection inside of an aircraft cockpit. The system according to the invention operates by interferometry. It comprises a fixed electro-optical device comprising one or more collimated point-like emission sources and a detection assembly comprising one or more point-like photosensitive detectors. Two or more retro-reflecting devices referred to as “cube corner” are disposed on the mobile object. This system can be completed by optical means operating in polarized light mode allowing the direction of variation of the interference fringes to be determined and by other optical devices allowing an initial orientation to be measured.

The field of the invention is that of position and/or orientation detection systems otherwise referred to as posture detection systems. One of the fields of application is helmet posture detection for aircraft pilots. This function allows the closed-loop control of, amongst other things, an image projected in the helmet display onto the external scene.

Many devices exist that implement various technologies. Detections using electromagnetic or optical principles will be mentioned, and systems implementing inertial sensors will also be mentioned.

However, for some applications, the system must have a high measurement precision, less than a milliradian. Whereas, for the large majority of the current detection systems, this barrier of a milliradian precision remains very difficult to overcome.

The detection system according to the invention allows relative measurements to be made of angular difference with a precision close to a microradian, a thousand times superior to the current precisions.

The general principle of the invention is based on an optical transmitter-receiver system composed of a coherent source illuminating a target, in the present case a pilot's helmet. The target splits the incident beam, by means of two retro-reflectors, into two beams phase-shifted with respect to one another as a function of the angle of rotation of the target with respect to the reference frame of the transmitter. The transmitter-receiver makes the two beams interfere, the number of interference fringes passing determining the value of a rotation between two orientations of the helmet. The measurement is therefore a differential angular measurement.

The retro-reflectors are cube corners. A cube corner allows a wavefront to be reflected back towards its source, whatever the orientation of the cube corner. If two cube corners are carried by the helmet, the first wavefront coming from the first cube corner exhibits a phase delay with respect to the second front coming from second cube corner; this delay is dependent on the orientation of the cube corners with respect to the incident wavefront.

The inter-fringe distance, which constitutes the smallest quantum measurable, is only dependent on the wavelength and on the geometry of construction of the cube corners when the source is at infinity. It corresponds to an extremely small angular displacement of the cube corners. Extremely precise measurements can thus be obtained, without significant optical means.

More precisely, the subject of the invention is a detection system for at least one rotation of a mobile object in space comprising at least:
a fixed electro-optical device with known orientation comprising:
   a first point-like emission source collimated by a optical lens;
   a semi-reflecting optical element and;
   a first photosensitive detection assembly, the first emission source and the first detection assembly being symmetrical with respect to the semi-reflecting optical element;
an assembly comprising two retro-reflecting devices referred to as “cube corner” disposed on the mobile object;
   characterized in that:
the first point source is a source of coherent light emitting at a first wavelength;
the two cube corners form an interferometer, in other words a first part of the light coming from the collimated source, retro-reflected by the first cube corner and focussed by the optical lens interferes on the first photosensitive detection assembly with a second part of the light coming from the collimated source, retro-reflected by the second cube corner and focussed by the optical lens, the signal received by the first photosensitive detection assembly depending on the orientation of the axis joining the two centres of the two cube corners.

Advantageously, the system comprises:
first optical means for image doubling disposed in such a manner as to create through the semi-reflecting optical element a first image and a second image of the first point-like emission source and;
a second detection assembly,
   the arrangement of the various optical elements being such that the first image of the first source is formed on the first photosensitive detection assembly and the second image of the first source is formed on the second photosensitive detection assembly, thus allowing the variations in orientation of the axis joining the centres of the first cube corner and of the second cube corner to be determined by the measurement of the two signals coming from the two detection assemblies.

Advantageously, the system comprises:
a third cube corner disposed on the mobile object;
a second coherent point-like emission source emitting at a second wavelength different from the first wavelength;
second optical means for image doubling disposed in such a manner as to create through the semi-reflecting optical element a first image and a second image of the second point-like emission source and;
a third photosensitive detection assembly and a fourth point-like photosensitive detection assembly,
   the arrangement of the various optical elements being such that the first image of the second source is formed on the third photosensitive detection assembly and the second image of the second source is formed on the fourth photosensitive detection assembly, thus allowing the determination of:
the variations in orientation with respect to two known axes of the first axis joining the centres of the first cube corner and of the second cube corner by the measurement of the two signals coming from the first two detectors and;
the variations in orientation with respect to two known axes of the second axis joining the centres of the first cube corner and of the third cube corner by the measurement of the two signals coming from the third and from the fourth detector.

Advantageously, the optical means for image doubling are composed of two semi-reflecting plane plates having a common side and whose normals make a predetermined angle different from zero.

Advantageously, at least one of the photosensitive detection assemblies comprises a single point-like detector.

Advantageously, at least one of the photosensitive detection assemblies comprises two point-like detectors separated by a polarization separator optical element, at least one of the cube corners comprising a linear polarizer, the fixed device or the said cube corner comprising a quarter-wave plate, thus allowing the direction of variation in the orientation of an axis joining the centres of the first cube corner and of the second cube corner to be determined by the measurement of the two signals coming from the two point-like detectors.

Advantageously, the detection system comprises mechanical or opto-mechanical means allowing the collimated beams emitted by the point source or sources to be oriented at a predetermined angle.

Advantageously, the detection system comprises optical means allowing an initial orientation of the cube corners to be determined, the said means comprising at least one source of collimated light referred to as initialization source and a photodetection matrix;

the mobile object comprising two plane mirrors disposed in different planes and having a known position with respect to the mobile object.

Preferably, the initialization source is the first collimated point-like emission source and the plane mirrors are two entry faces of the cube corners.

Lastly, if the system is a posture detection for an aircraft cockpit, the mobile object is a pilot's helmet.

The invention will be better understood and other advantages will become apparent upon reading the description that follows presented by way of non-limiting example and thanks to the appended figures amongst which:

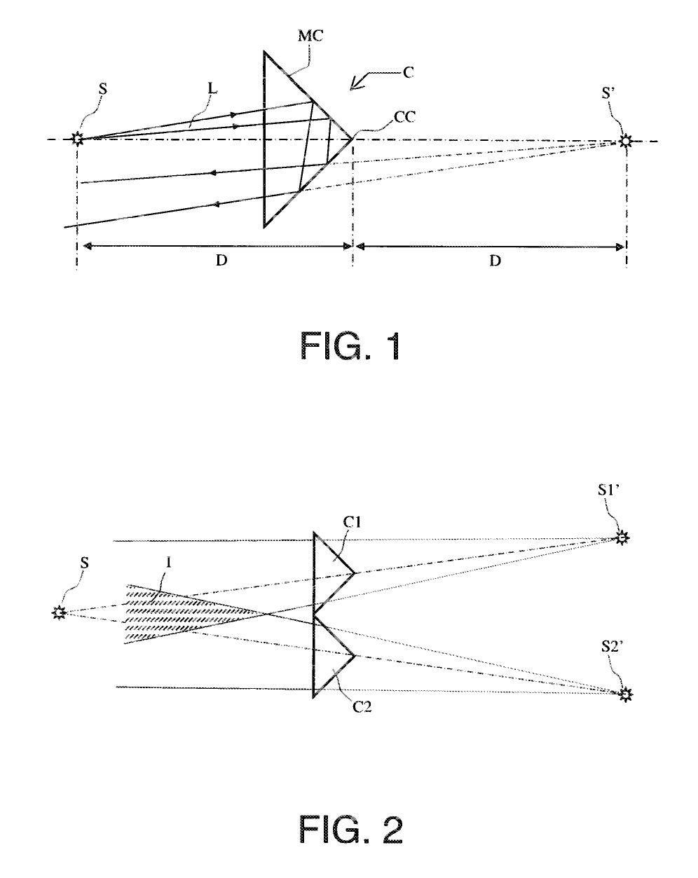

FIG. 1 shows the principle of operation of a cube corner;

FIG. 2 shows the principle of operation of an interferometer with two cube corners;

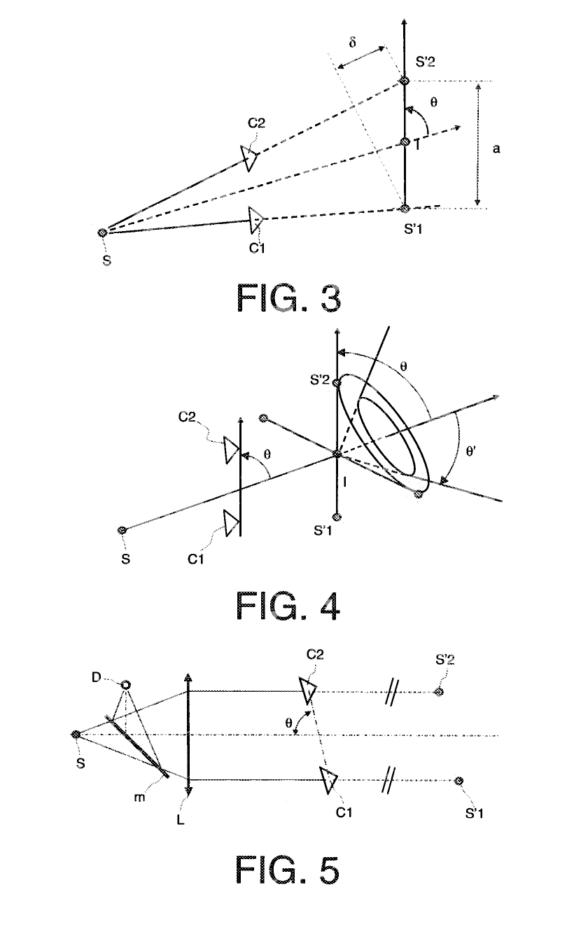

FIGS. 3 and 4 show the relationship linking the inter-fringe spacing of the interference system, the distance of the apices of the cube corners and their orientation;

FIG. 5 shows the general principle of the detection system according to the invention;

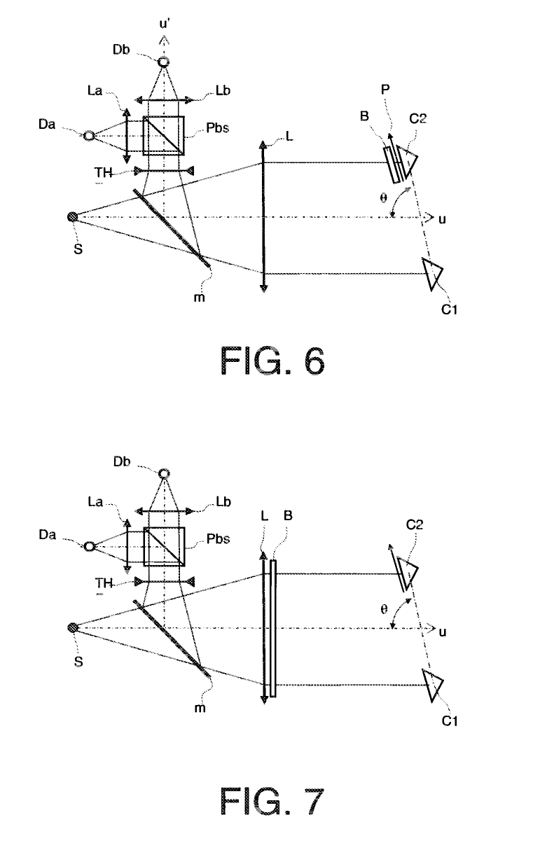

FIGS. 6, 7 and 8 show a first variant of the system according to the invention allowing the direction of the displacements of the interference fringes to be measured;

FIGS. 9, 10 and 11 present the general geometrical principles allowing the optimum configurations of the emission sources to be determined allowing the variations in orientation to be measured in one or in two orientation axes;

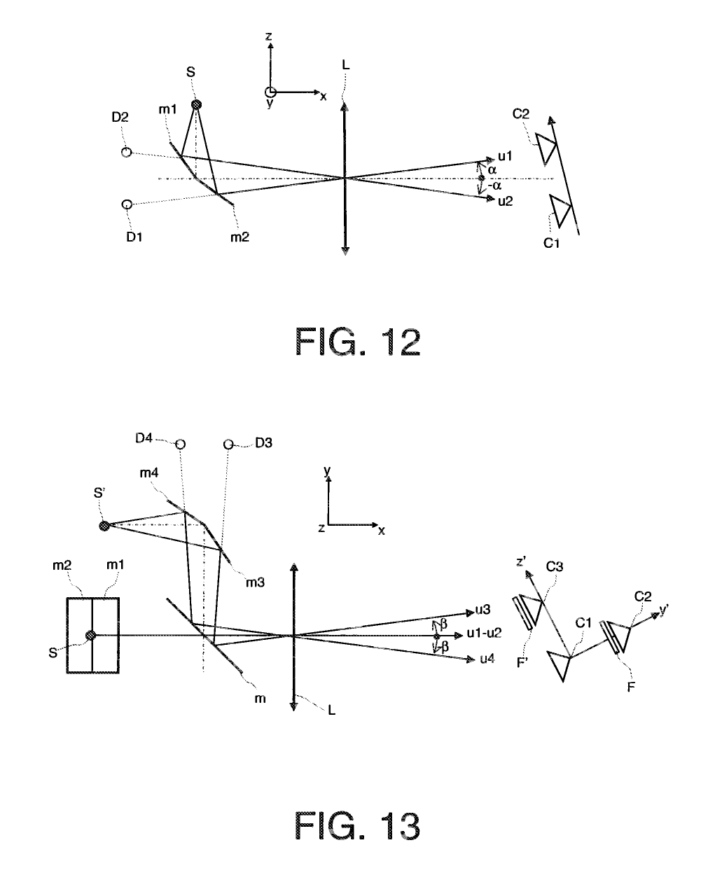

FIG. 12 shows a first configuration of the “two cube corner” system according to the invention allowing a measurement of variation in orientation of an axis to be made;

FIG. 13 shows a second configuration of the “three cube corners” system according to the invention allowing a measurement of variation in orientation of two axes to be measured;

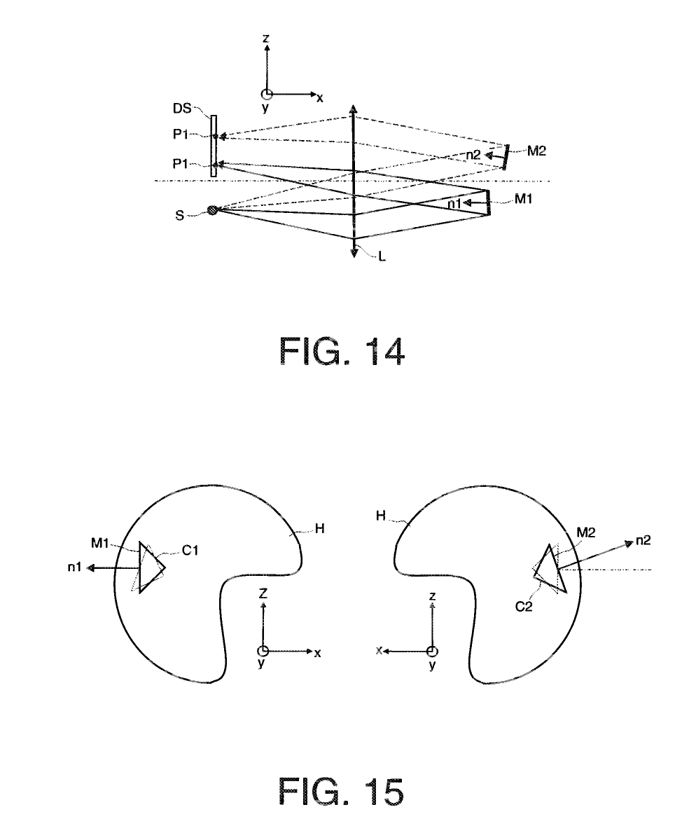

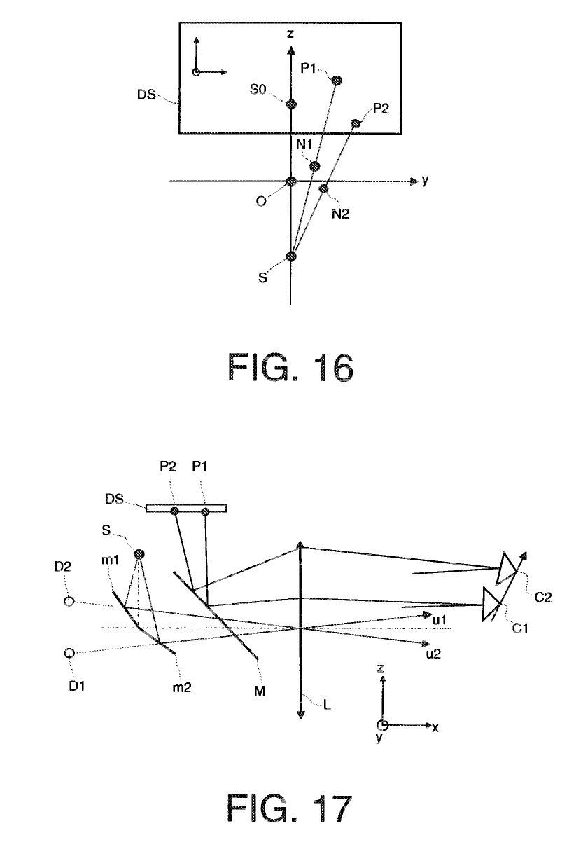

FIGS. 14 and 16 show the principle of an optical initialization device;

FIG. 15 shows the installation on the helmet of the cube corners in the framework of an optical initialization device;

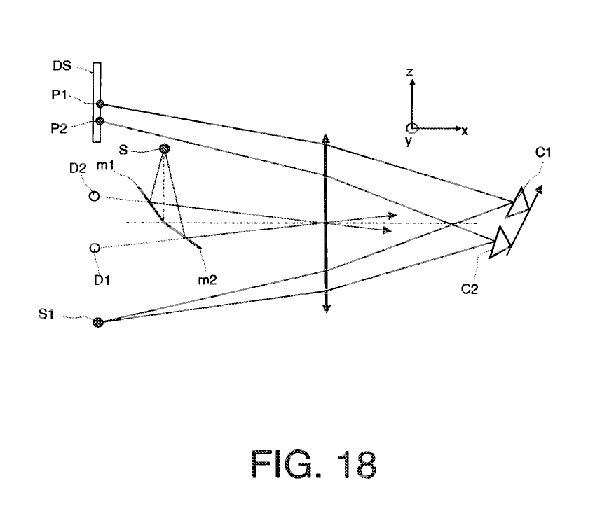

FIGS. 17 and 18 show the installation of an optical initialization device in the optical system according to the invention.

For the clarity of the presentation, the description hereinbelow is organized in several parts. The first part presents the general principles of interferometry using cube corners, the second part describes the means allowing the direction of the variation in the orientation of an axis to be determined, the third part describes in a general manner the detection systems according to the invention according to whether the orientation of one axis or of two axes is measured. The fourth part deals with the problem of the initialization of the system and of the means for implementing this. Finally, a last part summarizes the advantages of the system according to the invention with respect to the optical systems of the prior art.

General Principles

‘Catadioptre’ is the name given to any optical reflector or retro-reflector having the property of reflecting a light beam in the same direction as its incident direction. There are various optical means for implementing this function. Of more particular interest in the following part of the description are retro-reflectors of the “cube corner” type given that they are simple to implement and have a high precision.

A “cube corner” C such as that shown in FIG. 1 is composed of three mutually orthogonal plane mirrors MC. For reasons of clarity, the plane of FIG. 1 is such that only two of the three mirrors are shown. The propagation of the light rays takes place in the plane of the figure. In this plane, the light rays only undergo two reflections on the mirrors MC. Thus, a light beam emitted by an emitter part S and illuminating the catadioptre C is re-emitted in the same direction towards a receiver part situated on the same axis as the source S with an excellent efficiency. It can easily be demonstrated that the image of the source S is a source S′ situated on an axis SC passing through the source S and the centre CC of the cube corner and at equal distance D from the latter. In the same way, any light beam which does not come from the source and which is incident on the catadioptre, does not, in principle, produce hardly any illumination towards the receiver part.

When an assembly is implemented comprising two cube corners C1 and C2 as shown in FIG. 2, the use of a coherent source S allows interference figures I to be generated between the images S1′ and S2′ thus generated by the cube corners C1 and C2, in the overlap region of the beams coming from the images S1′ and S2′ and by relying on the pupil generated by each cube corner C1 and C2.

As indicated in FIG. 3, when the axis joining the apices of the cube corners rotates by an angle θ, the axis joining the two images S1′ and S2′ rotates by the same angle θ, and this displacement of the images of the source S induces a step difference δ between the two beams coming from the virtual images S1′ and S2′. This step difference δ is equal to a·cos(θ), a representing the distance between the two images S1′ and S2′,

or again a=2·C1C2.

Thus, when the angle of rotation goes from θ to θ′, the variation of step difference Δδ is equal to:

Δδ=a·cos(θ)−cos(θ′))

The places with same step difference, for a fixed position of the middle of C1C2 are therefore cones of angle θ at the apex as indicated in FIG. 4.

It is known that the step difference Δδ corresponding to an interference fringe is equal to λ, the mean wavelength of the emission source S. Thus, in order to go from one fringe to another, the angular difference between the angles θ and θ′ just needs to verify:

$$cos ( θ ) - cos ( {θ}^{′} ) = \frac{λ}{a}$$

In other words, an extremely small difference. Consequently, measurements of variations in orientation can be made with a very high sensitivity.

From a practical point of view, the detection system according to the invention must at least comprise, as indicated in FIG. 5, a point source S of wavelength λ that has a sufficient temporal coherence in order to create interference fringes. This source S with a known position and collimated by the lens L illuminates at least two cube corners C1 and C2 mounted on a mobile object not shown in FIG. 5. As has been said, in the large majority of applications, the mobile object is a helmet disposed within an aircraft cockpit.

A photodetector D placed symmetrically to the source S with respect to a semi-reflecting plate m sees the fringes crossing its view that come from interferences generated by the two images S1′ and S2′ at infinity originating from the same source. The step difference generating these fringes only depends on the inclination θ, with respect to the axis of the collimator, of the axis joining the two cube corners C1 and C2.

This simple system in FIG. 5 allows a relative measurement to be carried out of the angular displacement of the axis joining the cube corners in a given direction. It suffices to count the number of fringes between two intervals of time, thus offering a precise measurement between an original orientation and a final orientation, without a calibration being necessary. Since the source S is collimated, the system is only sensitive to the rotation and completely insensitive to the translations of the mobile object.

The spatial coverage of the device is determined by the zone covered by the transmitter. This device may therefore be used in several different modes of use.

In a first embodiment, the system according to the invention can be used as a high differential precision system with a small movement in translation. It allows a detection of variation in orientation within a reduced volume of detection with fixed emission-reception optics. More operationally, the system then mainly measures small movements in a very precise manner by providing an unequalled precision. It is thus possible to measure a precise angular difference between two targets or two orientations, visually designated by the wearer of the helmet. Aside from a high precision, this system allows the latency of a conventional posture detection, that carries out fixed measurements at regular intervals and hence is significantly delayed beyond a certain angular speed, to be corrected. The device according to the invention avoids the speed being an issue, because it provides the time interval between two angular quanta.

In a second embodiment, the system comprises a device for initial alignment. Currently, in aircraft, the high precision of the conformity of the symbols with respect to the external scene is not achieved by devices mounted on a helmet but is obtained by a device known as an “HUD” for “Head-Up Display” which superimposes synthetic images onto the external scene. The HUD is positioned in a fixed and precise manner within the cockpit. It displays critical symbols such as the runway axis, the velocity vector or the sight crosshairs.

The high precision of the system according to the invention can overcome this problem inherent to the employment of helmet visual displays and can contribute to eliminating the HUD from the cockpit, in this case, it is of course necessary for the system according to the invention to have an initialization device that will allow the system to be “locked onto” a perfectly defined orientation reference. Various techniques exist that allow this initialization to be implemented. Optical means may of course be set up allowing this function to be carried out. Such means are described in the following part, where a totally optical system is thus provided.

The detection system according to the invention can then be associated with a conventional posture detection. The system according to the invention covers a reduced field with a very high precision and the conventional posture detection covers a wider field with a lower precision.

In a third embodiment, in order to obtain greater movements in translation, the system includes a mirror mounted onto a two-axis pivoting platform and a closed-loop control device for this mirror. The incident beam or beams coming from the emission source or emission sources automatically adjusts its orientation towards the cube corners mounted on the mobile object in such a manner as to constantly illuminate it. The closed-loop control system is composed of a secondary incoherent source imaged on the pivoting mirror via a suitable set of optics. Its image by the cube corners supplies two return images which move with the translation of the cube corners. A simple 4-quadrant barycentric detector corrects the pivoting mirror in rotation in such a manner as to balance the distribution of the light intensities detected on the four quadrants so as to re-centre the beams coming from the sources. It should be noted that, whatever the orientation given by the pivoting mirror, the system with cube corners returns the retro-reflected beams in the direction of the incident beam; the imprecision of the pivoting system does not affect the overall precision of the detection system.

The latter system with pivoting mirror may be associated, as in the previous embodiments, with an initialization device.

### Detection of the Direction of Variation in the Orientation

The signal coming from the detector Is a sinusoidal signal. It varies in the same manner as the fringes travel in one direction or in the opposite direction. This ambiguity on the direction of travel of the fringes needs to be lifted. The simplest way consists in forming a double train of fringes or “interleaved fringes”. This method is used in interferometry for determining the direction of the movements of one arm of the interferometer.

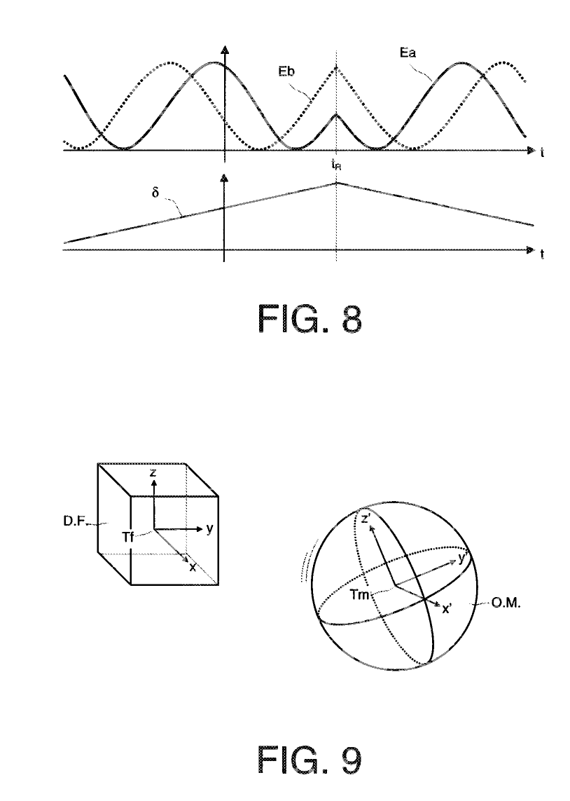

FIGS. 6 and 7 show the optical setup for this method in a system according to the invention. FIG. 8 shows the signals coming from the two detectors Da and Db shown in FIGS. 6 and 7.

In FIG. 6, the unpolarized radiation from the laser source S collimated along an axis u is, after reflection on one of the two reflectors, for example C2, circularly polarized by a bi-refringent quarter-wave plate B which is fixed in front of C2 and a linear polarizer P which is interposed between C2 and the plate B. This polarizer is oriented at 45° to the neutral lines of the plate B, the latter being perpendicular to each other. As long as the angle of incidence θ on the plate B remains small, the resulting polarization at the exit of B is circular. For large values of the angle of incidence θ, the resulting polarization is elliptical. The reflecting coating on the faces of the cube corners must of course be chosen such that they conserve the polarization of the incident light rays.

At low angles of incidence, the polarization coming from C2 may be decomposed into two linear polarizations along two perpendicular axes, in any given directions in the plane perpendicular to the direction of the rays. These two polarizations are mutually phase-shifted by +π/2.

The detection of the maxima of intensity resulting from the interference of the beam of polarized light coming from C2 with the depolarized beam reflected by C1 is carried out by means of:
a polarization separator cube Pbs illuminated with collimated
radiation thanks to the diverging optics L′,
two point-like detectors Da and Db respectively associated with the focussing lenses La and Lb disposed at the exit of the separator cube.

One variant of the device in FIG. 6 is shown in FIG. 7. This variant embodiment consists in placing a larger bi-refringent plate B in front of the collimator L, perpendicularly to the axis u, in such a manner as to use this plate at zero angle of incidence, the linear polarizer P itself still operating at variable angle of incidence.

Since the polarization coming from C2 is circular and the radiation coming from C1 is depolarized, the orientation of the cube Pbs about the direction u′ of the radiation, extension of the axis u by the retro-reflecting mirror m, can be any given angle with respect to that of the polarizer P in the plane of the entry face of the plate B.

The constant phase difference between the two polarizations results in a phase-shift between the curves of illumination on the detectors as a function of the angle θ. This phase-shift is equal to +π/2 for one direction of variation of θ and −π/2 for the opposite direction of variation. FIG. 8 presents the form of variation of the two illuminations Ea and Eb obtained on the two detectors Da and Db as a function of time t produced by a variation in the step difference δ, hence of cos θ, that is linear as a function of time, with a change of direction which corresponds to the angular points of the three curves at time t_{R}.

The number n of fringes between two orientations of the axis C1C2 is obtained by successively counting up and counting down the maxima according to the sign of the delay between the signals produced by Da and by Db. For large values of the angle of incidence θ on the polarizer P and on the bi-refringent plate B, the elliptical polarization produced by the plate B leads to the following phenomena:
an imbalance between the intensities transmitted by the two channels of the analyser Pbs for the radiation coming from C2 through B, which results in a fall in the contrast of the fringes on each detector;
a variation in the phase difference φ between the maxima of Da and of Db which is no longer exactly π/2, but which nevertheless changes sign depending on the direction of variation of the angle of incidence θ, the measurement of the phase difference φ remaining usable as long as the angle of incidence φ remains sufficiently different from π.

In the general case, the variations in the angle of incidence θ and in cos θ can be of any value, the period of the fringes is then variable, and the phase difference φ is then only in the neighbourhood of +π/2.

The determination of the direction of variation of cos θ, a direction which is always opposite to that of the variation of the angle of incidence θ for θ varying from 0 to π, is carried out by analysis of the position in time tb of the maximum of the signal produced by Db with respect to the middle of two consecutive maxima ta and t′a of the signal produced by Da:
if tb>(ta+ta′)/2, then the signal from Db is in advance over that from Da and the phase difference φ>0 hence d(cos θ)/dt>0, hence dθ/dt<0.
if tb<(ta+ta′)/2, then the signal from Db is delayed over that from Da and the phase difference φ>0 hence d(cos θ)/dt<0, hence dθ/dt>0.

Thus, it is always possible, within an angular range of at least two fringes, to determine the direction of variation of the fringes and, consequently, the direction of variation in orientation of the axis measured.

### Detection Systems

As indicated in FIG. 9, the fixed device DF of the detection system according to the invention is referenced in a direct orthonormal fixed reference frame Tf and the mobile object OM in a reference frame Tm (x′, y′, z′). The orientation of Tm with respect to Tf is entirely described by the rotational matrix M (3×3) which connects the unit vectors \vec{i}, \vec{j}, \vec{k}′ of the axes x′, y′, z′ of Tm to the unit vectors \vec{i}, \vec{j}, \vec{k} of the axes x, v, z of Tf. M may be written in the conventional form

$$M = ( \begin{matrix}a 1 & b 1 & c 1 \\ a 2 & b 2 & c 2 \\ a 3 & b 3 & c 3\end{matrix} ) .$$

The columns of this matrix M are the components of the unit vectors of Tm in the fixed reference frame Tf. The orientation of the mobile reference frame Tm with respect to the fixed reference frame Tf can be determined by the known orientations of two axes v and w in the mobile reference frame Tm.

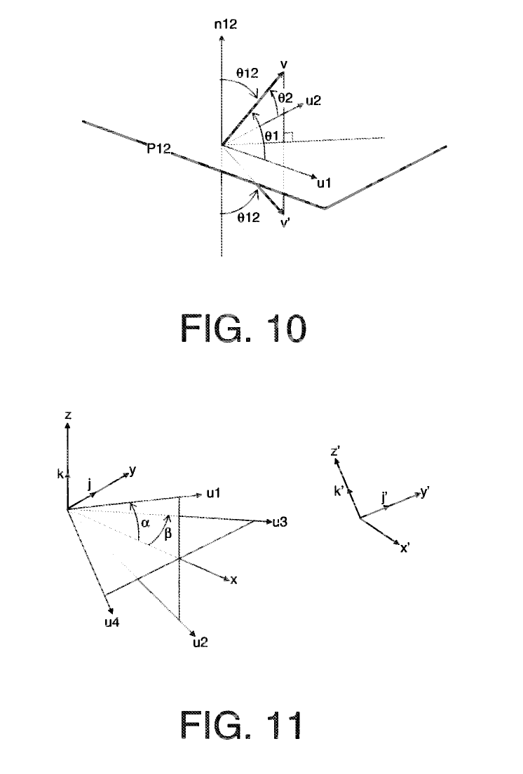

As has been seen, it is possible to determine by means of the system according to the invention the orientation 6 of an axis with respect to an axis of emission or of illumination u1 by means of the creation of a system of fringes. The creation of two different systems of fringes therefore allows two orientations θ1 and θ2 of a mobile axis v to be measured. However, an unknown mobile axis v defined by its unsigned orientations θ1 and θ2, measured with respect to two known fixed axes u1 and u2, is not unique. Indeed, if a mobile axis v satisfies this double condition, its symmetrical counterpart v′ with respect to the plane defined by u1 and u2, also satisfies the same as can be seen in FIG. 10.

The lifting of ambiguity between these two solutions consists in limiting the angular field of orientations of the mobile axis v, in such a manner as to always reject one of the two mobile axes v or v′ outside of the angular domain of the solutions. The mobile axis v is constrained to remain within the same half-space bounded by the plane P12 defined by the two axes u1 and u2, as can be seen in FIG. 10.

This condition is verified when the orientation θ12 of v with respect to the normal at n12 to the plane P12 containing u1 and u2 remains in the domain [0, π/2], or \vec{v}·(\vec{u}1 [symbol] \vec{u}2)>0, [symbol] being the symbol of the vector product.

The unknown unit vector is denoted

$$\vec{v} = ( \begin{matrix}x \\ y \\ z\end{matrix} ) .$$

The unit vectors of the two known fixed axes are denoted:

$$\overline{u} 1 = ( \begin{matrix}A 1 \\ B 1 \\ C 1\end{matrix} ) and \overline{u} 2 = ( \begin{matrix}A 2 \\ B 2 \\ C 2\end{matrix} ) .$$

The measured angles θ1 and θ2 satisfy the equations: \vec{v}·\vec{u}1=cos(θ1) and \vec{v}·\vec{u}2=cos(θ2). The three unknowns x, y and z therefore satisfy:

x·A1+y·B1+z·C1=cosθ1

x·A2+y·B2+z·C2=cosθ2

x²+y²+z²=1

The first two equations supply the separate expressions for x and for y in that form of linear functions of z. By replacing, in the third equation, the values for x and for y by these expressions, an equation of the second order in z is obtained.

It can be easily shown that the two mobile axes v and v′ corresponding to the two roots z and z′ of this equation are linked by: \vec{v}·(\vec{u}1 [symbol] \vec{u}2)=−\vec{v}′·(\vec{u}1 [symbol] \vec{u}2)

Therefore, only the root which satisfies: \vec{v}·(\vec{u}1 [symbol] \vec{u}2)>0 is conserved. As has just been seen, the orientation of the mobile axis v is measured with respect to two fixed axes of illumination u1 and u2. The orientation of a second mobile axis w allowing the orientation of a mobile object to be totally determined is measured with respect to two different fixed axes of illumination u3 and u4.

A maximum angular movement of the helmet of π/2 with respect to its “mean” orientation is sought while at the same time complying with the conditions: \vec{v}·(\vec{u}1 [symbol] \vec{u}2)>0 and \vec{w}·(\vec{u}3 [symbol] \vec{u}4)>0 The fixed axes are therefore chosen such that the plane (u1, u2) is perpendicular to the mean direction of the mobile axis v and that the plane (u3, u4) is perpendicular to the mean direction of the mobile axis w. The mean direction is that starting from which the maximum angular movement is desired.

Preferably, it is advantageous to adopt the following configuration:
Mean orientation of the mobile reference frame parallel to that of the fixed reference frame;
Mobile axes v and w are mutually perpendicular;
Mobile axes v and w coincident with the two axes y′ and z′ of the mobile reference frame.

The following features, indicated in FIG. 11, result from the above:
The fixed axes u1 and u2 are in the plane (zOx), for example pivoted by angles α and −α with respect to the axis x;
The axes u3 and u4 are in the plane (yOx), for example pivoted by angles β and of β with respect to the axis x;
The condition for lifting the indetermination of the mobile axis y′ is: \vec{j}′·\vec{j}>0, or: b2>0 In other words y′ always in the left-hand half-space of the vertical plane zox;
The condition for lifting the indetermination of the mobile axis z′ is: \vec{k}′·\vec{k}>0, or: c3>0 In other words the axis z′ always in the half-space above the horizontal plane yox.

It is possible to construct a detection system whose optical architecture complies with the previous geometrical considerations, thus simplifying the measurement and allowing it to be performed without ambiguities.

By way of a first non-limiting example, FIG. 12 shows a schematic diagram of a system according to the invention allowing the angular variation of a first mobile axis to be measured in two directions of orientation. For reasons of clarity, the optical device for lifting the ambiguity in direction of variation in orientation of the segment C1C2 with respect to the axes u1 and u2 is not shown in this figure. It essentially comprises a bi-refringent plate, a linear polarizer, polarization and image doubling separator prisms for each detector and four detectors, two per measurement channel. The opto-mechanical setup for this device does not pose any particular problem.

The mobile object, which is for example a helmet, comprises two reflectors C1 and C2. They are illuminated from the same source S, by two collimated beams, in two different directions u1 and u2 respectively offset by angles α and −α with respect to the axis x by means of
a collimating lens L with optical axis x,
a device known as a “double Fresnel mirror” composed of two plane mirrors m1 and m2 pivoted about an axis y perpendicular to the axis x, by angles α/2 and −α/2 with respect to the axis x. The mirrors m1 and m2 are therefore mutually offset by the angle α. They are semi-reflecting in such a manner as to be used for the emission and for the reception.

The interferences produced by the reflectors C1 and C2 in the direction u1 are measured by the detector D1, symmetrical to S with respect to m1 and the interferences produced by the reflectors C1 and C2 in the direction u2 are measured by the detector D2, symmetrical to S with respect to m2, as can be seen in FIG. 12. The device referred to as “double Fresnel mirror” may of course be replaced by other devices allowing the same function to be carried out, in other words the creation of two images from the same emission source.

By way of a second non-limiting example. FIG. 13 shows a schematic diagram of a system according to the invention allowing the angular variation of two mobile axes to be measured with respect to two directions of orientation. The orientation of a mobile object in space can be determined by this second system.

A third reflector 03 is added onto the helmet and a second fixed source S′ is added as can be seen in FIG. 13. For simplicity, the cube corner C3 is disposed such that C1C3 is perpendicular to C1C2. b/2 denotes the distance separating the apices of the cube corners C1 and C3. The segment joining the apices of the cube corners C1 and C2 forms the first mobile axis y′ and the segment joining the apices of the cube corners C1 and C3 forms the second mobile axis z′.

The first source emits at the wavelength λ. The second source S′ emits at a wavelength λ′ different from λ. The two sources are collimated by the lens L with the aid of the semi-transparent or wavelength selective mirror m. The source S is combined at the detectors D1 and D2 by the semi-transparent mirrors m1 and m2 and the source S′ is combined at the detectors D3 and D4 by the semi-transparent mirrors m3 and m4.

The mirrors m3 and m4 are respectively pivoted by angles β and −β with respect to the axis y about the axis z perpendicular to the axis y.

It is, of course, fundamental that the detectors D1 and D2 only capture the signals coming from the cube corners C1 and C2 and that the detectors D3 and D4 capture the signals coming from the cube corners C1 and C3 such that the signals are representative of a single axis. A simple way of carrying out this discrimination is to use sources emitting in different spectral bands λ and λ′ and to dispose in front of the cube corners C2 and C3 spectral filters F and F′ only transmitting one of the two spectral bands.

The detectors D1, D2, D3 and D4 supply, by counting up/down, the numbers n1, n2, n3 and n4 of over-bright or under-bright bands for each of the four interference figures respectively generated by:
The source S emitting at the wavelength λ and illuminating the reflectors C1 and C2 in the direction of the axis u1;
The source S emitting at the wavelength λ and illuminating the reflectors C1 and C2 in the direction of the axis u2;
The source S′ emitting at the wavelength λ′ and illuminating the reflectors C1 and C3 in the direction of the axis u3;
The source S′ emitting at the wavelength λ′ and illuminating the reflectors C1 and C3 in the direction of the axis u4.

As in FIG. 12, the devices for lifting the ambiguity in the direction of variation in orientation of the segment joining C1 and C2 with respect to the axes u1 and u2 and that of the segment joining C1 and C3 with respect to the axes u3 and u4 are not shown in FIG. 13.

The initial orientation Tm0 (O, x′0, y′0, z′0) of the mobile orthonormal reference frame Tm with respect to the known fixed reference frame Tf (x, y, z) is assumed to be known. It is given by the rotational matrix M0:

$$M 0 = ( \begin{matrix}a 10 & b 10 & c 10 \\ a 20 & b 20 & c 20 \\ a 30 & b 30 & c 30\end{matrix} )$$

The final orientation of the mobile orthonormal reference frame Tm (O, x′, y′, z′) with respect to the fixed reference frame Tf (x, y, z) is unknown. It is expressed by the rotational matrix M sought:

$$M = ( \begin{matrix}a 1 & b 1 & c 1 \\ a 2 & b 2 & c 2 \\ a 3 & b 3 & c 3\end{matrix} )$$

Between these two orientations Tm0 and Tm, the four detectors D1, D2, D3, D4 have respectively counted up and counted down n1, n2, n3 and n4 light intensity maxima at the wavelengths λ and λ′ corresponding to these changes in orientation.

The components of the unit vectors of the fixed axes of illumination by S at the wavelength λ are:

$$\overline{u} 1 = ( \begin{matrix}cos α \\ 0 \\ sin α\end{matrix} ) and \overline{u} 2 = ( \begin{matrix}cos α \\ 0 \\ - sin α\end{matrix} ) with 0 < α < π / 2$$

The orientation of the mobile axis y′ with unit vector \vec{j}′ is given by:

θ1=angle (\vec{u}1, \vec{j}′), or: cosθ1=\vec{u}1·\vec{j}′

θ2=angle (\vec{u}2, \vec{j}′), or: cosθ2=\vec{u}2·\vec{j}′

The orientations have therefore respectively gone from θ10 to θ1 and from θ20 to θ2. Simple equations then result from the principle of the measurement itself:

cos θ1−cos θ10=n1·λ/a
cos θ2−cos θ20=n2·λ/a a/2 being the distance separating the apices of the cube corners C1 and C2.

It is demonstrated that the components b1 and b3 verify the following equations:

b1=b10+[(n1+n2)λ/2a·cos α]

b3=b30+[(n1−n2)λ/2a·sin α]

The component b2 is given by the equation: b1²+b2²+b3²=1 giving:

b2=(1−b1²−b3²)^{0.5}

The second root of the equation, i.e. b2=−(1−b1²−b3²)^{0.5}, being negative, therefore falls outside of the domain of validity defined by b2 positive.

The calculation is similar to the preceding one for the components c1, c2 and c3 of the third column of the matrix M.

The components of the two unit vectors of the fixed axes of illumination by S′ at the wavelength λ′ are:

$$\overline{u} 3 = ( \begin{matrix}cos β \\ sin β \\ 0\end{matrix} ) and \overline{u} 4 = ( \begin{matrix}cos β \\ - sin β \\ 0\end{matrix} ) with 0 < β < π / 2$$

The orientation of the mobile axis z′ with unit vector k′ is given by:

θ3=angle(\vec{u}3, \vec{k}′), or: cos θ3=\vec{u}3·\vec{k}′

θ4=angle(\vec{u}4, \vec{k}′) or: cos θ4=\vec{u}4·\vec{k}′

As previously, this gives:

c1=c10+[(n3+n4)λ′/2b·cos β]
c2=c20+[(n3−n4)λ′/2b·sin β], b/2 being the distance separating the apices of the cube corners C1 and C3

The component c3 is gven by c3=(1−c1²−c2²)^{0.5}

The second root c3=−(1−c1²−c2²)^{0.5}, being negative, therefore falls outside of the domain of validity defined by c3 positive.

The components of the vector \vec{i}′ are the coefficients a1, a2, a3 of the first column of the matrix M

They are given by: \vec{i}′=\vec{j} [symbol] \vec{k}′ (vector product), giving:

a1=b2·c3−b3·c2

a2=b3·c1−b1·c3

a3=b1·c2−b2·c1

Consequently, based on the known coefficients of the matrix M0 for initial orientation of the helmet, the orientations of the light emitting device u1, u2, u3, u4, known by construction, and the four measurements from the counting of fringes n1, n2, n3, and n4, the nine coefficients of the matrix M are determined which yield, in the fixed reference frame Tf, the orientation of the mobile reference frame Tm fixed to the helmet.

Initialization

As has been seen, the system according to the invention used alone allows relative measurements of orientation to be made based on a known original orientation. In order to perform absolute measurements, an initialization device is needed allowing an initial orientation of the mobile object to be precisely determined. Various dispositions are possible. However, it may be advantageous to use, in part, the optical means already installed for the measurement of the variation in orientation.

Such an optical device for precisely measuring an initial orientation of the helmet is described in FIGS. 14 to 18.

FIG. 14 shows a side view of such a device. Two mirrors M1 and M2 fixed onto the helmet, for example the entry faces of two of the three cube corners C1 and C2, have known different orientations that are close to one another. By way of example. FIG. 15 shows a possible arrangement of the two cube corners C1 and C2 and of the two mirrors M1 and M2 on a helmet H. FIG. 15 comprises, on the right, a side view of a helmet and, on the left, the same view from the opposite side. In this FIG. 15, the normals n1 and n2 to the entry faces M1 and M2 and their difference in inclination are shown.

The collimated light beam produced by a source S, coherent or otherwise, is reflected separately by these two mirrors M1 and M2. The direction of each of the two reflected beams is measured by the positions P1 and P2 of each reflection on a surface detector DS placed on the focal plane of the collimator L. FIG. 16 shows the impacts of the positions P1 and P2 and the position of the source S in a plane perpendicular to that in FIG. 14. The four coordinates of the positions P1 and P2 thus acquired allow the three parameters of orientation of the helmet to be calculated at any time, in a reduced angular field, about a given orientation.

The surface detector with position DS is advantageously a matrix detector of the CCD type, if N is the number of points of resolution on each axis, the angular precision is equal to the ratio of the angular field over this number N. Thus, for N equal to 1000 points and for an angular field equal to 1 degree, an angular precision of around 1 thousandth of a degree, or 17 microradians, is obtained.

One of the advantages of this device is that it can be integrated, in part, into the system according to the invention. A first example of association with an orientation detection system is shown in FIG. 17. The detection system is that in FIG. 12 and it allows the detection of orientation according to a particular axis. In the same way, the device for measuring initial orientation can be integrated into a two-axis detection system.

The source S illuminates the cube corners with a double incidence in the directions u1 and u2. M is a semi-reflecting mirror separating the light beams, which, coming from the reflection by the cube corners C1 and C2, interfere at D1 and D2 with the beams coming from the reflection on the front faces of the same cube corners.

Of course, the alignment may also be carried out by means of another, potentially incoherent, source that may furthermore only be switched on during the alignment.

A second example of association is shown in FIG. 18. This configuration this time avoids the addition of the semi-reflecting mirror M. It consists of the use of a second source S1, and in using the periphery of the field of the collimator for illuminating and for receiving the reflected light. The incident intensities on the front faces of the cube corners are increased accordingly.

Advantages of the System

With respect to the optical systems of the prior art and in the framework of an application as a helmet posture detection system, the system according to the invention offers the following advantages:
Very simple to implement due to the use of light sources not having any particular specifications, of simple optics and of point-like photosensitive detectors;
Very simple calculations required for the determination of the orientation and the position of the helmet;
High resolution of order of magnitude 10 μrad and a high measurement precision, far superior to the performances of the current systems;
Absence of significant modifications to the helmet owing to the use of entirely passive optical devices added onto the helmet;
Significant immunity to sunshine interference owing to the use of reflecting cube corners.

1. Detection system for at least one angle of rotation of a pilot's helmet in space comprising at least:
a fixed electro-optical device with known position and orientation comprising:
a first point-like emission source collimated by an optical lens;
a semi-reflecting optical element and;
a first photosensitive detection assembly, the first emission source and the first detection assembly being symmetrical with respect to the semi-reflecting optical element;
an assembly comprising two retro-reflecting devices referred to as “cube corner” disposed on the pilot's helmet; wherein:
the first point source is a source of coherent light emitting at a first wavelength;
the two cube corners form an interferometer, in other words a first part of the light coming from the collimated source, retro-reflected by the first cube corner and focussed by the optical lens, interferes on the first photosensitive detection assembly with a second part of the light coming from the collimated source, retro-reflected by the second cube corner and focussed by the optical lens, the signal received by the first photosensitive detection assembly depending on the orientation of the axis joining the two centres of the two cube corners.

2. Detection system according to claim 1, wherein the system comprises:
first optical means for image doubling disposed in such a manner as to create through the semi-reflecting optical element a first image and a second image of the first point-like emission source and;
a second detection assembly,
the arrangement of the various optical elements being such that the first image of the first source is formed on the first photosensitive detection assembly and the second image of the first source is formed on the second photosensitive detection assembly, thus allowing the variations in orientation with respect to two known axes of the axis joining the centres of the first cube corner and of the second cube corner to be determined by the measurement of the two signals coming from the two detection assemblies.

3. Detection system according to claim 2, wherein the system comprises:
a third cube corner disposed on the mobile object;
a second coherent point-like emission source emitting at a second wavelength different from the first wavelength;
second optical means for image doubling disposed in such a manner as to create through the semi-reflecting optical element a first image and a second image of the second point-like emission source and;
a third photosensitive detection assembly and a fourth point-like photosensitive detection assembly,
the arrangement of the various optical elements being such that the first image of the second source is formed on the third photosensitive detection assembly and the second image of the second source is formed on the fourth photosensitive detection assembly, thus allowing the determination of:
the variations in orientation with respect to two known axes of the first axis joining the centres of the first cube corner and of the second cube corner by the measurement of the two signals coming from the first two detectors and;
the variations in orientation with respect to two known axes of the second axis joining the centres of the first cube corner and of the third cube corner by the measurement of the two signals coming from the third and from the fourth detector.

4. Detection system according to claim 2, wherein the optical means for image doubling are composed of two semi-reflecting plane plates having one common side and whose normals make a predetermined angle different from zero.

5. Detection system according to claim 1, wherein at least one of the photosensitive detection assemblies comprises a single point-like detector.

6. Detection system according to claim 1, wherein at least one of the photosensitive detection assemblies comprises two point-like detectors separated by a polarization separator optical element at least one of the cube corners comprising a linear polarizer, the fixed device or the said cube corner comprising a quarter-wave plate, thus allowing the direction of variation in the orientation of the axis joining the centres of the first cube corner and of the second cube corner to be determined by the measurement of the two signals coming from the two point-like detectors.

7. Detection system according to claim 1, wherein the detection system comprises mechanical or opto-mechanical means allowing the collimated beams emitted by the point source or sources to be oriented by a predetermined angle.

8. Detection system according to claim 1, wherein:
the detection system comprises optical means allowing an initial orientation of the cube corners to be determined, the said means comprising at least one source of collimated light referred to as initialization source and a photodetection matrix;
the pilot's helmet comprising two plane mirrors disposed in different planes and having a known position with respect to the pilot's helmet.

9. Detection system according to claim 1, wherein the initialization source is the first collimated point-like emission source and in that the plane mirrors are two entry faces of the cube corners.
